(19) United States
(12) Patent Application Publication
(10) Pub. No.: US 2009/0091095 A1
(43) Pub. Date: Apr. 9, 2009

(54) PNEUMATICALLY ELEVATABLE HAND TRUCK

(75) Inventor: John Donlin, Seattle, WA (US)

Correspondence Address: BLACK LOWE & GRAHAM, PLLC, 701 FIFTH AVENUE, SUITE 4800, SEATTLE, WA, 98104, US

(73) Assignee: SHAMROCK LIFTS, INC., Seattle, WA (US)

(21) Appl. No.: 11/868,356

(22) Filed: Oct. 5, 2007

(51) Int. Cl. B60P 1/02; B60S 9/00; B60S 9/02

(52) U.S. Cl. 280/6.153; 254/423; 280/6.15

(57) ABSTRACT

A pneumatic cylinder assembly and a method for lifting a hand truck frame generally vertically away from a ground surface exploits a cylinder housing including a longitudinal axis and first and second ends. The cylinder housing defines a cylinder cavity at the first end and a port generally at the second end in operative communication with the cylinder cavity and has at least one frame attachment point for attachment of the housing to the hand truck frame. A piston in the cylinder cavity is moveable in a first direction. A fluid space is defined between the actuation surface within the cylinder housing. An inlet valve is configured to admit a working fluid into the fluid space through the port at a pressure greater than an ambient pressure, thereby urging the piston in the first direction thereby to cause the movement of the piston in the first direction lifting the truck.

### FIELD OF THE INVENTION

This invention relates generally to hand trucks and, more specifically, to pneumatically energized hand trucks.

### BACKGROUND OF THE INVENTION

A hand truck is an L-shaped payload-moving dolly having a frame including one or two handles located generally at an uppermost end. The frame is configured to rotate about an axle connecting wheels at a frame base. Extending from the base in opposed relation to the handle or handles is a tongue configured to support a payload. The tongue generally rests flat against a ground surface when the hand-truck is upright.

The payload to be moved is placed upon the tongue. The frame is tilted away from the tongue lifting the payload allowing gravity to urge the payload into engagement with the frame. The payload is tilted back about the axle until the payload weight is balanced over the wheels. Used in such a fashion, the hand truck is used to transport bulky and heavy objects, making them easier to move, based upon the simple lever. The hand truck will not, however, significantly elevate a payload to lift that payload onto a sill of a delivery van or onto a loading dock.

A number of solutions have been taught. In U.S. Pat. No. 2,875,852 (Mar. 3, 1959), Morrell taught the use of a power driven handling truck, having a very significant overall weight and an elaborate pulley mechanism to elevate the payload on the tongue. Likewise, Gibson in U.S. Pat. No. 2,925,887 (Feb. 23, 1960) taught a hand truck having both a significant base element and a fork elevating hydraulic ram. The Gibson solution is both heavy and unwieldy.

In U.S. Pat. No. 3,055,523 (Sep. 25, 1962), Wurn taught the use of a manually telescoping hand truck gaining mechanical advantage through the use of cranks spooling cables through pulleys. The telescoping hand truck proved to offer too little a mechanical advantage to be useful. Vermett, et al. taught a refinement of the telescoping hand truck in U.S. Pat. No. 4,421,209 dated Dec. 20, 1983.

The foregoing solutions bear similar earmarks of failure. The trucks have heavy bases supporting elaborate lifting structures. The hand trucks are heavy, large and unwieldy. What is needed in the art is a light, simple, elevating means that is neither overly complicated nor unduly heavy.

### SUMMARY OF THE INVENTION

A pneumatic cylinder assembly and a method for lifting a hand truck frame generally vertically away from a ground surface exploits a cylinder housing including a longitudinal axis and first and second ends. The cylinder housing defines a cylinder cavity at the first end and a port generally at the second end in operative communication with the cylinder cavity and has at least one frame attachment point for attachment of the housing to the hand truck frame. A piston in the cylinder cavity is moveable in a first direction. A fluid space is defined between the actuation surface within the cylinder housing. An inlet valve is configured to admit a working fluid into the fluid space through the port at a pressure greater than an ambient pressure, thereby urging the piston in the first direction to cause the movement of the piston in the first direction lifting the truck.

An embodiment of the present invention comprises a pneumatically elevating hand truck. AS hand truck frame assembly includes a frame and two wheels spaced apart on an axle. The axle is attached to the frame to allow ready movement of the hand truck frame assembly along a ground surface. A tongue extends from the frame and configured for bearing a load. A fluid cylinder assembly includes a cylinder tube attached to the frame at frame attachment points. The cylinder has a port and encloses a piston having an actuating surface. The piston is fitted into the cylinder tube to be slidable in the cylinder tube. A piston rod is integrally fitted to the piston at a first rod end and extends away from the piston to a second rod end. A portion of the rod including the second end protrudes outside the cylinder tube by a protrusion amount. The protrusion amount is of the rod is changed according to entrance and exit of fluid into and out of a chamber the cylinder defines in conjunction with the activation surface. A control valve is configured to selectively allow entrance and exit of the working fluid into and out of the chamber.

In accordance with some non-limiting examples of the invention, elevating and lowering a hand truck relative to a ground surface includes attaching a cylinder assembly having a longitudinal axis at frame attachment points to a hand truck. The longitudinal axis is oriented as generally vertical. The hand truck has a frame and an axle attached to the frame. The axle has two wheels spaced apart and configured for movement of the hand truck over a ground surface. A fluid is admitted into the cylinder assembly. The cylinder assembly includes at least one port, and first and second ends situated in first and second directions respectively along the longitudinal axis and defining a cylinder cavity at the first end. A piston is situated in the cylinder cavity, has an actuation surface and is moveable along the longitudinal axis. A fluid space exists between the actuation surface and the cylinder cavity and will receive the admitted fluid. A piston rod is connected to the piston at a first rod end. The piston rod has a first rod end attached to a piston and spaced apart from the actuation surface in the first direction along the longitudinal axis. A second rod end is further spaced apart in the first direction from the actuation surface and is configured to engage the ground surface. Expanding the fluid spaces exploits a differential pressure force in the first direction caused by the presence of the admitted fluid which drives the piston and piston rod in the first direction. The hand truck is lifted by movement of the piston rod in the first direction bearing against the ground surface at the second rod end.

These and other examples of the invention will be described in further detail below.

### BRIEF DESCRIPTION OF THE DRAWINGS

Preferred and alternative examples of the present invention are described in detail below with reference to the following drawings:

FIG. 1 is a perspective view of an embodiment of a hand truck with a piston rod extended;

FIG. 2 is a reverse perspective view of an embodiment of the hand truck with the piston rod retracted;

FIG. 3 is front view of an embodiment of the hand truck with the piston rod retracted;

FIG. 4 is a side view of an embodiment of the hand truck with the piston rod retracted;

FIG. 5 is a rear view of an embodiment of the hand truck with the piston rod retracted;

FIG. 6 is a front view of an alternate embodiment of the hand truck with the piston rod retracted and an auxiliary reservoir;

FIG. 7 is a rear view of an embodiment of the hand truck with the piston retracted showing a sill;

FIG. 8 is a rear view of an embodiment of the hand truck with the piston extended;

FIG. 9 is a side view of an embodiment of the hand truck with the piston extended demonstrating the rotational movement about the piston;

FIG. 10 is a side view of an embodiment of the hand truck with the piston extended demonstrating the removal of the payload;

FIG. 11 is a side view of an embodiment of the hand truck with the piston partially extended demonstrating the retraction of the piston rod;

FIG. 12 is a rear view of an embodiment of the hand truck with the piston partially extended demonstrating the rotation of the hand truck about the piston rod;

FIG. 13 is a rear view of an embodiment of the hand truck with the piston retracted demonstrating the self centering rotation of the hand truck about the piston rod caused by engagement with cradles on a foot;

FIG. 14 is a cross-sectional view of the cylinder assembly showing the piston rod retracted; and

FIG. 15 is a cross-sectional view of the cylinder assembly showing the piston rod extended.

### DETAILED DESCRIPTION OF THE PREFERRED EMBODIMENT

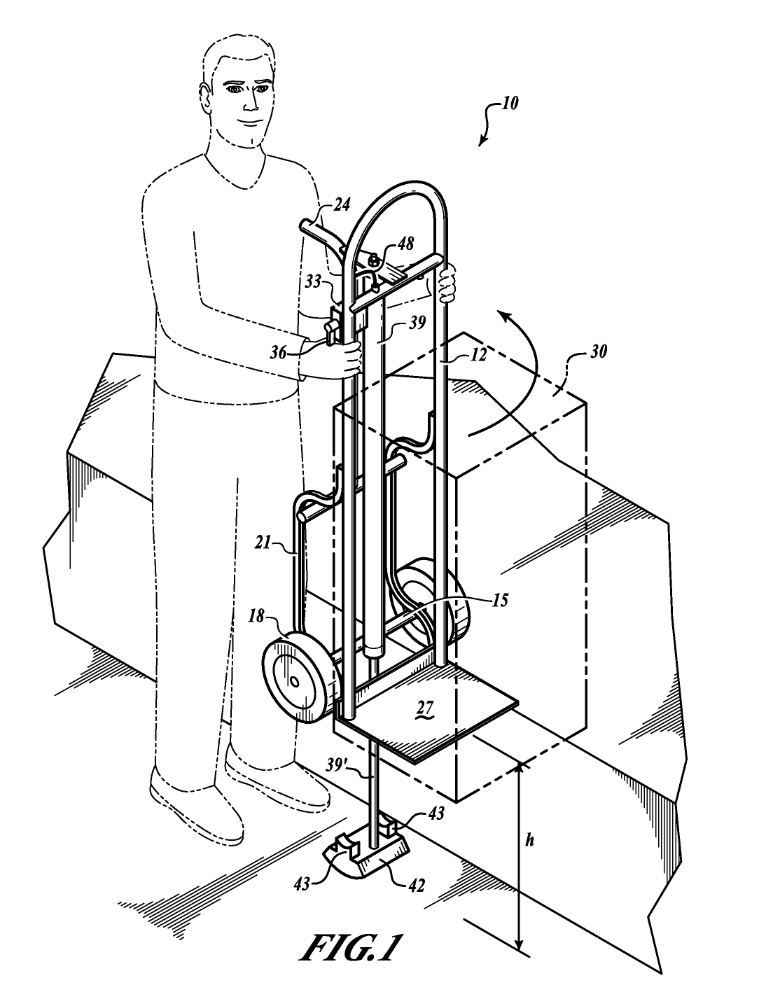

The addition of a pneumatic cylinder assembly to a hand truck provides a light, simple, hand truck elevating means that is neither overly complicated nor unduly heavy. Referring to FIG. 1, a perspective view of an embodiment of a hand truck assembly with a piston rod 39′ extended, demonstrates the easy and natural use of the inventive hand truck assembly 10. The hand truck assembly 10 includes a hand truck frame 12 which, in one non-limiting embodiment, is hollow to receive a charge of compressed working fluid (generally, compressed air is used as a working fluid, however, there is no reason that any compressed gas, such as carbon dioxide, could not serve with equal facility). Affixed to the hand truck frame 12, are an axle 15, about which two wheels 18 rotate in contact with a ground surface, a tongue 27 for supporting a payload (not shown) and generally one or more handles 24 used to tilt the hand truck frame 12 about the axle 15 to lift a payload (not shown) residing on the tongue 27. Generally, the rigidity of the frame is enhanced by the inclusion of a support assembly 21 including stringers used to buttress the axle 15 where it joins the frame 12.

In addition to those above-listed elements, the hand truck assembly 10 shares with a conventional hand truck, additionally, an actuator valve assembly 33 which selectably communicates the working fluid from the reservoir the frame 12 contains through the cylinder feed conduit 48, to a cylinder assembly 39 enveloping the piston rod 39′. A charging nipple 51 and charging hose assembly 54 also communicate with the reservoir in the frame 12 to allow charging of the reservoir with the working fluid. By selectably actuating the actuator valve assembly 33, the operator can elevate the hand truck assembly 10 by allowing the fluid to flow from the frame 12 to the cylinder assembly 39 where it urges the piston (not shown) and the attached piston rod 39′ to extend from the cylinder assembly. A foot 42 attached to the piston rod 39′ in opposed relation to the piston (not shown) contacts the ground surface to support and, by further extension of the piston rod 39′ from the cylinder assembly 39, to elevate the hand truck assembly 10 relative to the ground surface. Shown on the upper surface of the foot 43 are optional cradles 43 that tend to align the foot 42 with the axle 15.

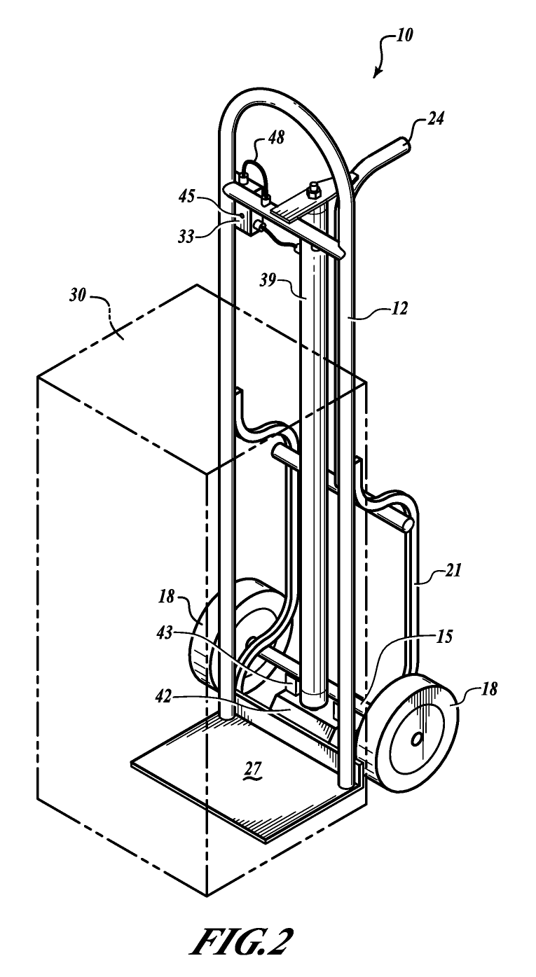

FIG. 2 depicts a reverse perspective view of the embodiment of the hand truck 10 with the piston rod 39′ retracted into the cylinder assembly 39. A payload 30 is shown in phantom resting on the tongue 27. As above, the axle 15 is affixed to the frame 12 by means of the support assembly 21. In turn, the wheels 18 are spaced apart and rotatably attached to the axle 15 allowing easy movement on the ground surface. To selectably extend and retract the piston rod 39′ and the attached foot 42, the actuator valve assembly 33 is shown along with an air exhaust horn 45 to facilitate the release of working fluid from the cylinder assembly 39 upon suitable activation of the actuator valve assembly 33, thereby allowing the piston rod 39′ to retract into the cylinder assembly 39. By means of alternate activation, the actuator valve assembly allows working fluid to pass under pressure (relative to the ambient) through the cylinder feed conduit 48, to pressurize the cylinder assembly 39 to elevate the hand truck assembly 10.

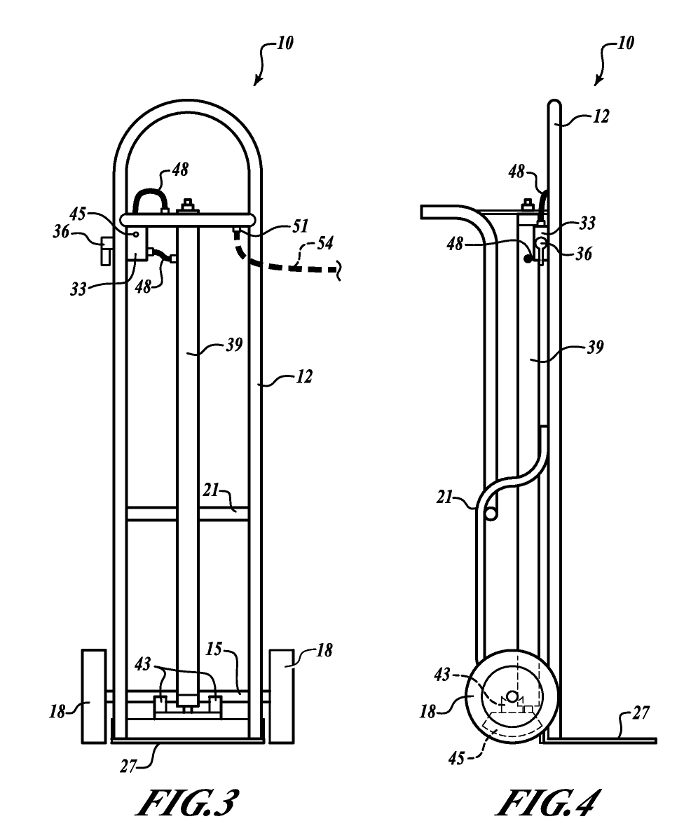

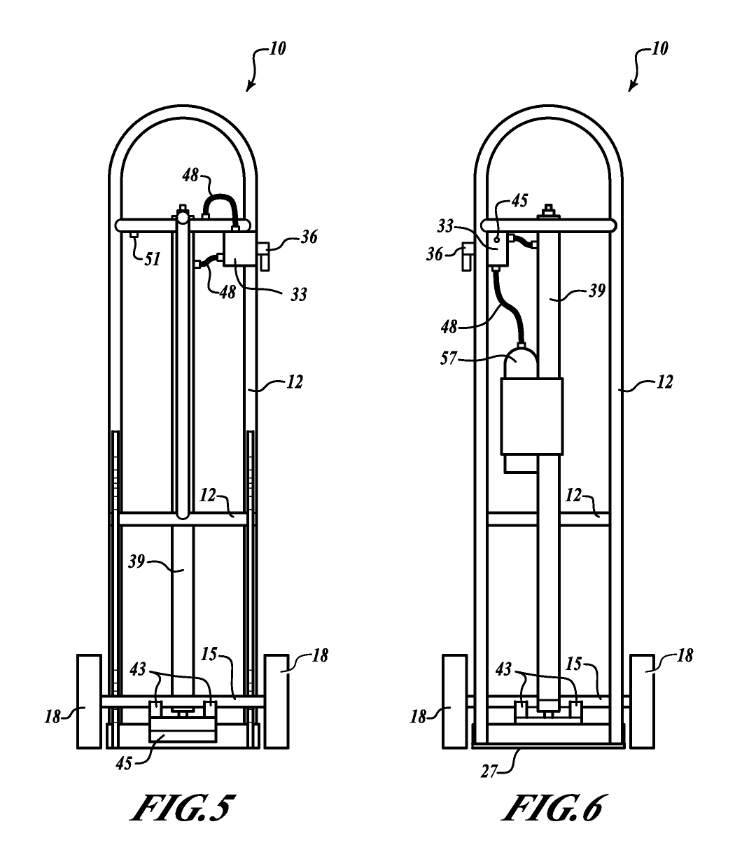

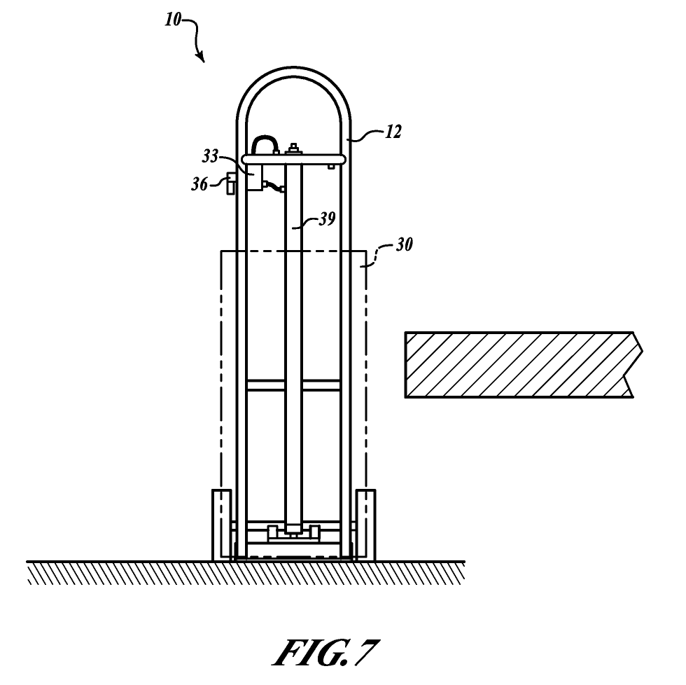

FIG. 3 is a front view, FIG. 4 a side view, and FIG. 5 a rear view of the embodiment of the hand truck assembly 10 with the piston rod 39′ retracted into the cylinder assembly 39. FIG. 6 is a front view of an alternate embodiment of the hand truck with the piston rod 39′ retracted and an auxiliary reservoir 57. These views show placement of the various components relative to the frame 12. To further clarify the elevating and lowering functions of the hand truck assembly 10, the fluid circuit will be described with reference to these FIGS. 3, 4, 5, and 6.

The working fluid is admitted to reside in the reservoir (depending upon the embodiment) contained either in the frame 12 or the auxiliary reservoir 57 through the charging hose assembly 54 into the charging nipple 51 which communicates with the reservoir. The working fluid resides in the reservoir under pressure until activation of the actuator valve assembly 33. When suitably activated, a valve within the actuator valve assembly allows the fluid to communicate with the cylinder assembly 39 by passing through the cylinder feed conduit 48 as it runs from the actuator valve assembly 33 to the cylinder assembly 39. Admitting the working fluid into the cylinder assembly 39 urges the piston rod 39′ to extend from the cylinder assembly 39′. In turn, the extension of the cylinder rod 39′ urges the foot 45 against the ground surface to elevate the hand truck assembly 10.

When the actuator valve assembly 33 is otherwise activated, the fluid returns through the cylinder feed conduit 48 from the cylinder assembly 39 through a valve in the actuator valve assembly 33 and is released to the ambient through the air exhaust horn 45. As a consequence of the release of fluid to the ambient, the pressure the fluid exerts on the piston, and in turn on the piston rod 39′, decreases, allowing the ambient pressure and gravity to urge the piston rod 39′ back into the cylinder assembly 39′, thereby lowering the hand truck. Because of the relationship which the pressure within the cylinder assembly has to the lifting force the foot exerts on the ground surface, selective actuation of the actuator valve assembly 33 allows controlled elevation and lowering of the hand truck assembly 10.

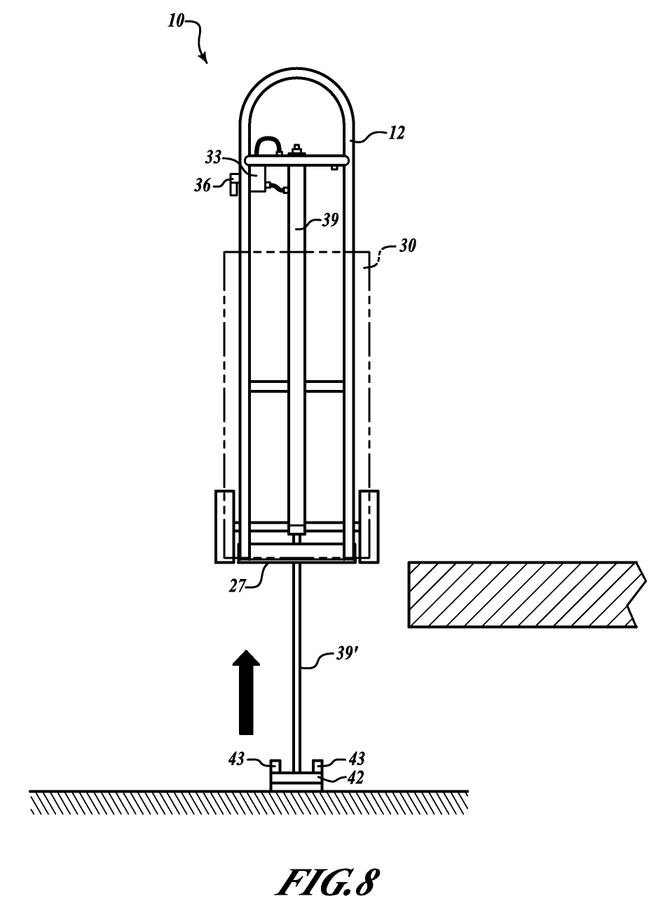

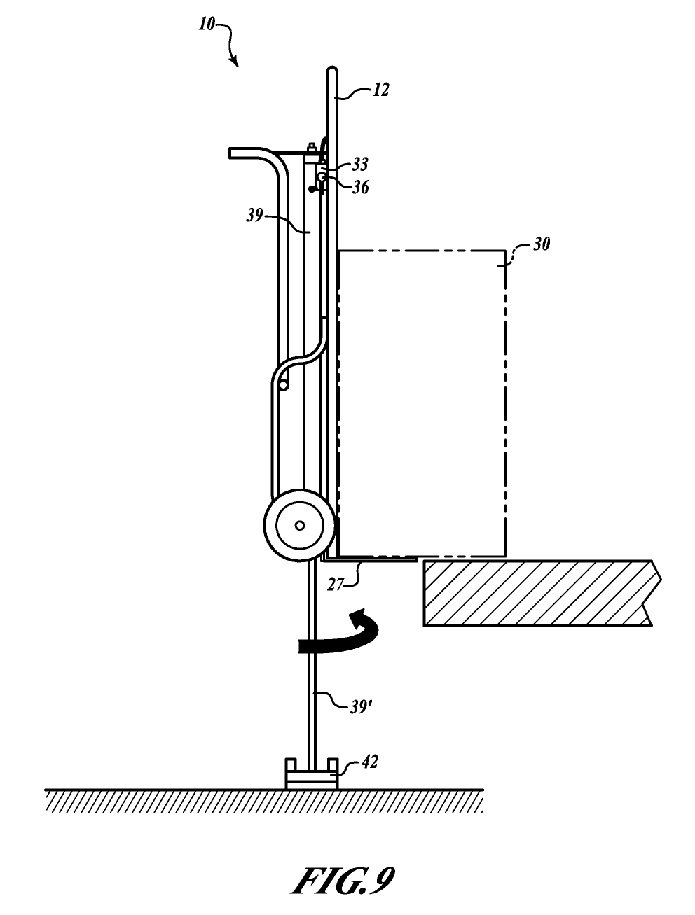

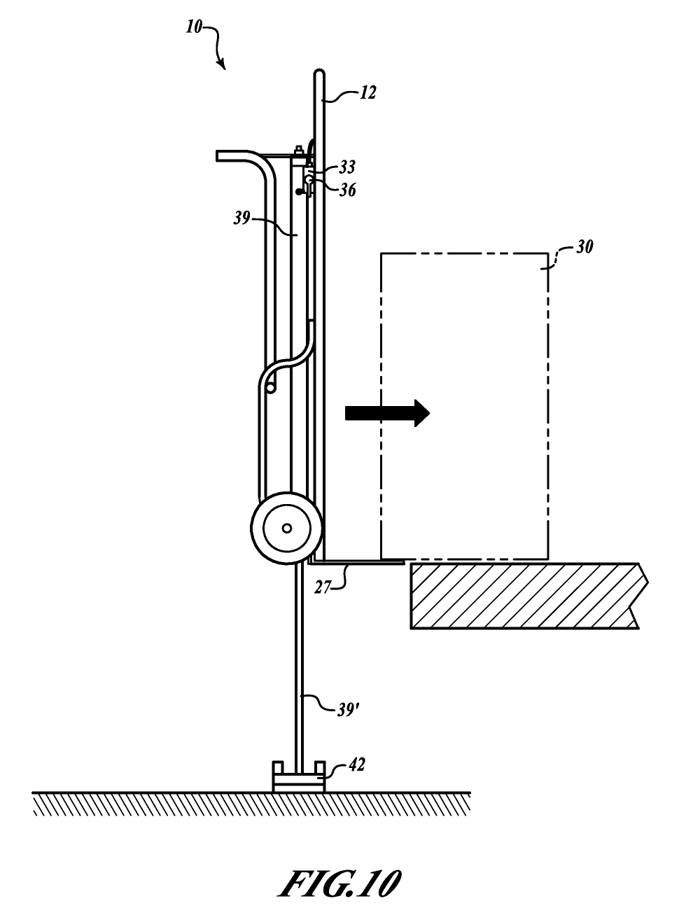

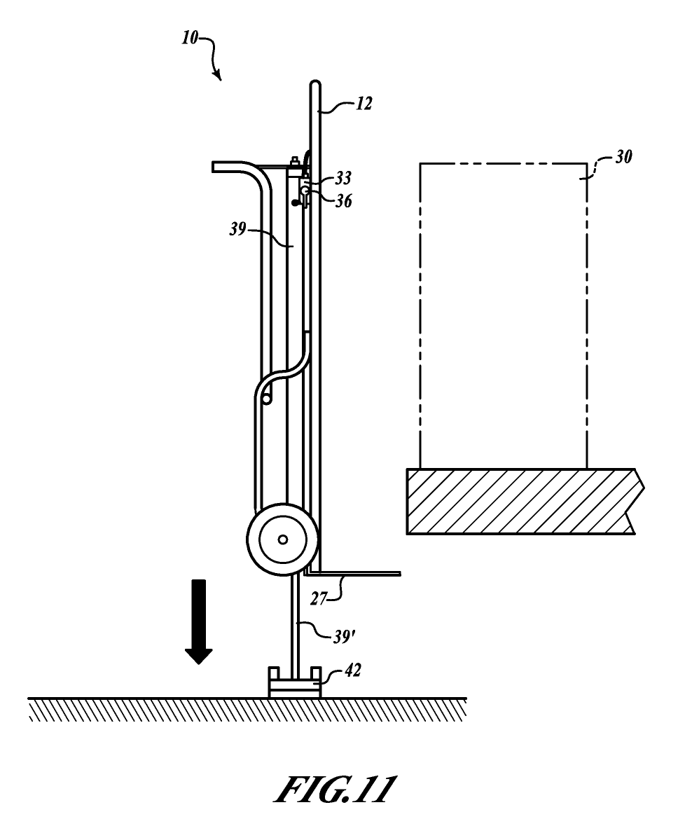

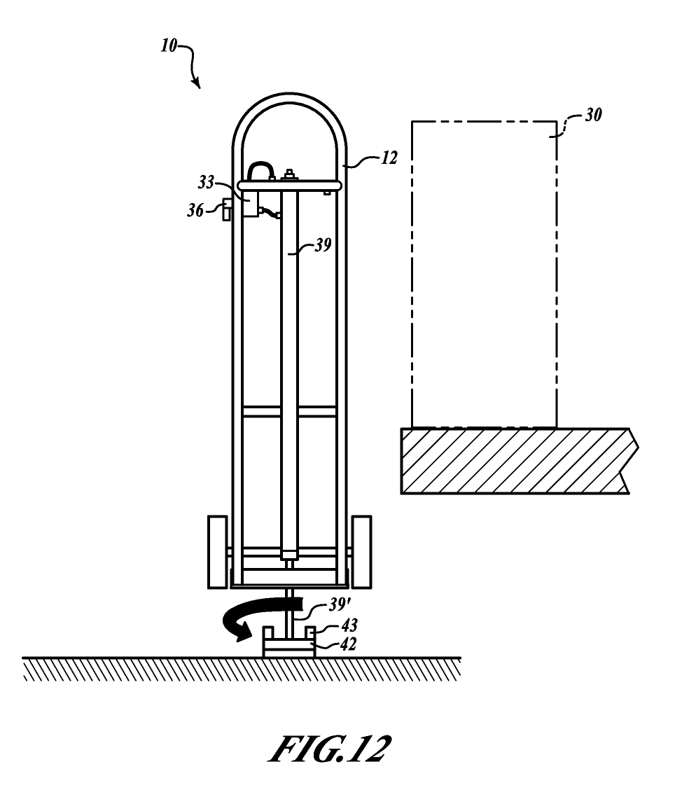

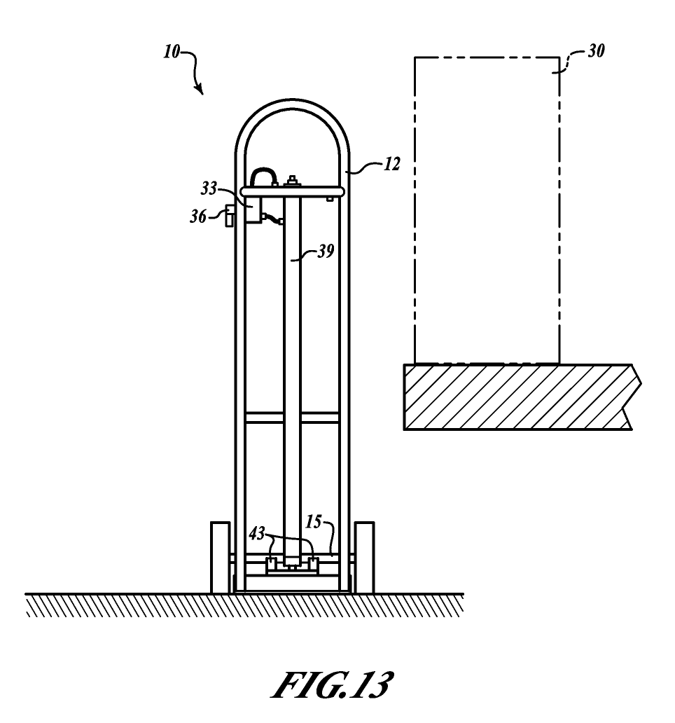

FIG. 7 is a rear view of an embodiment of the hand truck with the piston retracted showing a sill; FIG. 8 is a rear view of an embodiment of the hand truck with the piston partially extended; FIG. 9 is a side view of an embodiment of the hand truck with the piston more fully extended; FIG. 10 is a side view of an embodiment of the hand truck with the piston extended; FIG. 11 is a side view of an embodiment of the hand truck with the piston partially extended; FIG. 12 is a rear view of an embodiment of the hand truck with the piston partially extended; and FIG. 13 is a rear view of an embodiment of the hand truck with the piston retracted. Together, these FIGS. 9-13 demonstrate, in sequence, a maneuver made possible by one non-limiting embodiment of the hand truck assembly 10. The cylinder assembly 39 and the piston and piston rod 39′ cooperate to form a fluid bearing which facilitates the maneuver shown in the sequence.

Fluid bearings are those which solely support the bearing's loads on a thin layer of liquid or gas. Fluid bearings generally have very low friction—far better than mechanical bearings. Since no rigid mechanical element supports load, it may seem that fluid bearings can give only low precision. In practice, fluid bearings have clearances that change less under load (are ‘stiffer’) than mechanical bearings. It might seem that bearing stiffness, as with maximum design load, would be a simple function of average fluid pressure and the bearing surface area. In practice, when bearing surfaces are pressed together, the fluid outflow is greatly constricted. This significantly increases the pressure of the fluid between the bearing faces. As fluid bearings' faces are comparatively large areas, even small fluid pressure differences cause large restoring forces, maintaining the gap. For that reason, the cylinder assembly 39 will readily pivot about the piston rod 39′, thereby allowing the hand truck assembly 10, when elevated, to pivot a payload onto a sill.

Initiating the sequence at FIG. 7, the payload 30 (shown in phantom) rests upon the tongue 27 and the hand truck assembly 10 stands adjacent to a sill selected as the desired location of the payload. By activating the actuator valve assembly, the fluid is allowed to escape the reservoir contained in the frame 12 (in the illustrated non-limiting embodiment), through the cylinder feed conduit 48 to the cylinder assembly.

FIG. 8 is a rear view of the embodiment of the hand truck with the piston rod 39′ partially extended as a result of the fluid entering the cylinder assembly 39. The payload 30 has been elevated on the tongue 27 of the hand truck assembly 10, as the hand truck assembly 10 elevates in response to the fluid entering the cylinder assembly 39.

FIG. 9 is a side view of the embodiment of the hand truck assembly 10 with the piston rod 39 more fully extended. As explained above, the piston rod 39′ in cooperation with the cylinder assembly 39 forms a fluid bearing that supports the weight of the hand truck assembly 10 with the payload 30 resting on the tongue 27. The hand truck assembly 10 is readily pivoted about the piston rod 39 to place the payload 30 on the sill.

FIG. 10 is a side view of the embodiment of the hand truck assembly 10 with the piston rod 39′ extended. In the illustrated position, the payload is readily moved from the tongue 27 to the sill, now being oriented to allow this movement. Upon the translational movement from the tongue 27 to the sill, the hand truck assembly 10 is unladen.

FIG. 11 is a side view of an embodiment of the hand truck assembly 10 with the piston rod 39′ partially extended as the actuator valve assembly 33 is activated to allow the working fluid to escape through the air exhaust horn 45. As a consequence of the air escaping the cylinder assembly 39, the piston rod 39′ retracts into the cylinder assembly 39. In this manner, the hand truck assembly 10 moves downward.

FIG. 12 is a rear view of an embodiment of the hand truck assembly 10 with the piston rod 39′ partially extended from the cylinder assembly 39. Once again, the piston rod 39′ and the cylinder assembly 39 cooperate to form a fluid bearing. The hand truck assembly 10 readily pivots about the piston rod 39′ to return to its original orientation.

In FIG. 13, an optional feature of the hand truck assembly 10 is demonstrated as the piston rod 39′ further retracts into the cylinder assembly 39′ to a point of repose. Cradles 43 located on an upper surface of the foot 45 engage the axle 15 in generally v-shaped cavities. Where the foot 45 is not in perfect alignment with the axle 15, the retraction of the piston rod 39′ into the cylinder assembly 39 urges the axle 15 into deeper engagement with the cradles 43, providing a rotational force to the foot 45, causing the foot 45 to draw into alignment with the axle 15.

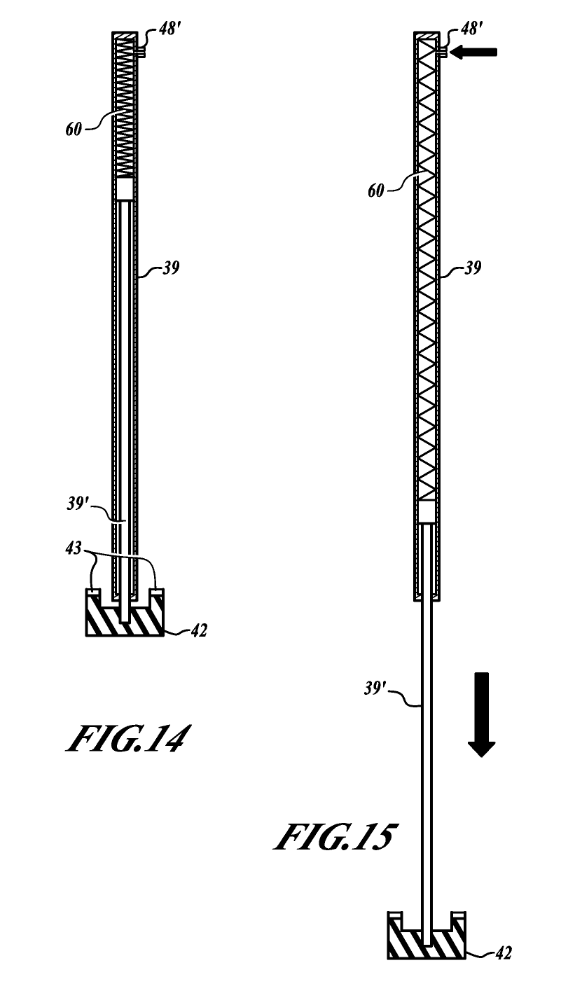

FIG. 14 is a cross-sectional view of the cylinder assembly showing the piston rod retracted; and FIG. 15 is a cross-sectional view of the cylinder assembly showing the piston rod extended. Together, FIGS. 14 and 15 demonstrate an additional non-limiting embodiment of the invention. As earlier explained, the piston rod 39′ is nestingly engaged in the cylinder assembly 39. The piston rod 39′ comprises a piston with an actuating surface configured to contain the fluid within a cylindrical cavity that the cylinder assembly 39 defines. When working fluid enters the cylinder cavity through the cylinder feed conduit nipple 48′, the fluid presses against the actuation surface driving the piston and piston rod 39′ downward.

In the non-limiting embodiment, a resilient member or spring 60 connects the cylinder assembly 39 to the piston rod 39′ biasing and, thus, urging the piston rod 39′ back into the position illustrated in FIG. 14. When fluid is admitted through the cylinder feed conduit nipple 48′ the pressure of the fluid overmasters the bias allowing the piston rod 39′ to extend relative to the cylinder assembly 39, thereby allowing the elevation of the hand truck assembly 10 as described above.

While the preferred embodiment of the invention has been illustrated and described, as noted above, many changes can be made without departing from the spirit and scope of the invention. For example, the hand truck assembly 10 may readily be configured to mate with a charging hanger on a van, thereby to recharge the fluid in the reservoir by the above-described means with each replacement of the hand truck assembly into the charging hanger. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A pneumatic cylinder assembly for lifting a hand truck frame generally vertically away from a ground surface, the cylinder assembly comprising:
a cylinder housing including:
a longitudinal axis and first and second ends, the cylinder housing defining a cylinder cavity at the first end and a port generally at the second end in operative communication with the cylinder cavity, and having at least one frame attachment point for attachment to the hand truck frame;
a piston in the cylinder cavity having an actuation surface and moveable along the longitudinal axis in a first direction toward the first end and a second direction opposed to the first direction and toward the second end;
a fluid space defined by the actuation surface within the cylinder housing; and
a rod connected to the piston at a piston interface on a first rod end, extending along the longitudinal axis to a second rod end, the piston interface being spaced apart in the first direction from the actuation surface, the second rod end configured to engage the ground surface; and
a control valve including:
an inlet valve configured to admit a working fluid into the fluid space through the port at a pressure greater than an ambient pressure, urging the piston in the first direction thereby to cause the movement of the piston in the first direction; and
an outlet valve configured to exhaust the working fluid through the port from the fluid space thereby allowing movement of the piston in the second direction.

2. The pneumatic cylinder assembly of claim 1, further including a spring biasing the piston in the second direction relative to the housing.

3. The pneumatic cylinder assembly of claim 1, wherein the port includes:
an intake port; and
an exhaust port.

4. The pneumatic cylinder assembly of claim 1, wherein the second rod end includes:
a foot configured to bear upon the ground surface.

5. The pneumatic cylinder assembly of claim 1, wherein the control valve includes a stabilizing handle.

6. The pneumatic cylinder assembly of claim 1, wherein the cylinder cavity, the piston, and the fluid space cooperate to form a fluid bearing permitting rotation of the cylinder housing about the piston rod

7. A pneumatically elevating hand truck comprising:
a hand truck frame assembly including:
a frame;
two wheels spaced apart on an axle, the axle being attached to the frame to allow ready movement of the hand truck frame assembly along a ground surface;
a tongue extending from the frame and configured for suspension of a load; and
a fluid cylinder assembly including:
a cylinder tube attached to the frame at frame attachment points, the cylinder further comprising a port;
a piston having an actuating surface and fitted into the cylinder tube to be slidable in the cylinder tube; and
a piston rod being integrally fitted to the piston at a first rod end and extending away from the piston to a second rod end, such that a portion of the rod including the second end, being protruded outside the cylinder tube, a protrusion amount of the rod is changed according to entrance and exit of fluid into and out of a chamber the cylinder defines in conjunction with the activation surface; and
a control valve configured to selectively allow entrance and exit of the working fluid into and out of the chamber.

8. The pneumatically elevating hand truck of claim 7, wherein;
the second rod end includes a foot having a bearing surface, the bearing surface being situated in opposed relation to the piston rod and configured to engage the ground surface.

9. The pneumatically elevating hand truck of claim 8, wherein the foot further includes at least one cradle configured to engage the axle aligning the foot to the axle, the cradle being situated in opposed relation to the bearing surface on the foot.

10. The pneumatically elevating hand truck of claim 7, wherein:
the frame includes a first handle situated to facilitate tilting of the hand truck about the axle.

11. The pneumatically elevating hand truck of claim 10, wherein:
the control valve includes a second handle spaced apart from the first handle and configured to stabilize the hand cart relative to rotation about the rod.

12. The pneumatically elevating hand truck of claim 7, wherein:
the cylinder tube further includes a spring biasing the piston in the second direction relative to the housing.

13. The pneumatically elevating hand truck of claim 7, further comprising a fluid reservoir configured to store the fluid under a pressure greater than an ambient pressure such that upon actuation of the control valve, fluid leaves the reservoir to enter the chamber.

14. The pneumatically elevating hand truck of claim 13, wherein the frame comprises the reservoir.

15. The pneumatically elevating hand truck of claim 13, further comprising a reservoir feed for admitting fluid into the reservoir under pressure

16. A method of elevating and lowering a hand truck relative to a ground surface, the method comprising:
attaching a cylinder assembly having a longitudinal axis and first and second ends situated in first and second directions respectively along the longitudinal axis and defining a cylinder cavity at the first end, the hand truck having a frame and an axle attached to the frame, the housing being attached to the frame at frame attachment points such that the longitudinal axis is generally vertical, the axle having two wheels spaced apart and configured for movement of the hand truck over a ground surface;
admitting a fluid into the cylinder assembly to urge a piston situated in the cylinder to move in the first direction along the longitudinal axis cavity, the piston having an actuation surface such that a fluid space defined by the actuation surface and the cylinder cavity receives the admitted fluid;
driving the piston and a piston rod connected to the piston at a first rod end spaced apart from the actuation surface in the first direction along the longitudinal axis in the first direction; and
lifting the hand truck by movement of the piston rod in the first direction bearing against the ground surface at a second rod end further spaced apart in the first direction from the actuation surface.

17. The method of claim 16, further comprising opening the port to allow the fluid to flow out of the fluid space, under pressure stored in a spring within the cylinder cavity urging the piston in the second direction.

18. The method of claim 16, further comprising rotating the hand truck about the longitudinal axis while the hand truck is being borne by fluid in the fluid space.

19. The method of claim 16, wherein the admitting includes activating a valve configured to selectably allow and stop the flow of fluid into the fluid space from a reservoir.

20. The method of claim 19, further comprising charging the reservoir with fluid under a pressure greater than an ambient pressure.
